(19) United States
(12) Patent Application Publication
(10) Pub. No.: US 2005/0200272 A1
(43) Pub. Date: Sep. 15, 2005

(54) Method for fabricating a high density integrated light-emitting device, and high density integrated light-emitting device

(75) Inventors: Isao Shimoyama, Tokyo (JP); Kiyoshi Matsumoto, Tokyo (JP); Kazunori Hoshino, Tokyo (JP); Koichi Yamada, Tokyo (JP)

Correspondence Address: OLIFF & BERRIDGE, PLC, P.O. BOX 19928, ALEXANDRIA, VA, 22320, US

(73) Assignee: THE UNIVERSITY OF TOKYO, Bunkyo-Ku (JP)

(21) Appl. No.: 11/037,212

(22) Filed: Jan. 19, 2005

(30) Foreign Application Priority Data
Jan. 23, 2004 (JP) 2004-15,475

(51) Int. Cl. H05B 33/14; H05B 33/22; H05B 33/08; H05B 33/10

(52) U.S. Cl. 313/503; 313/504; 445/24

(57) ABSTRACT

A plurality of electrode pairs are prepared. The electrode pieces of each electrode pair are opposite to one another. Then, voltages are applied to the electrode pairs so as to accumulate illuminants in between the electrode pieces of the electrode pairs by using the electric fields generated between the electrode pieces from the voltages.

### BACKGROUND OF THE INVENTION

1. Field of the Invention

This invention relates to a method for fabricating a high density integrated light-emitting device, and a high density integrated light-emitting device.

2. Related Art

A conventional light-emitting device of pn-junction type, which is fabricated by doping Al, P or In into GaAs or GaN, is widely available in present displaying field. Also, a light-emitting element made of an organic EL element, which is fabricated by sandwiching the TDP and the Alq3 with the metallic electrodes, is being developed as a main technology of the present flat panel displaying field, so that the area of the light-emitting element is being enlarged remarkably and the resolution of the light-emitting element is being also enhanced remarkably. Moreover, recently, attention is paid to a light-emitting element which is fabricated by sandwiching the inorganic semiconductor nano-particles with the metallic electrodes.

In the conventional pn-junction type light-emitting diode, however, it is difficult that minute light sources which can emit the respective lights with the different wavelengths are integrated high density on the same chip. Moreover, in the conventional organic EL element and a conventional inorganic EL element, it is required that a plurality of illuminants are formed through patterning. In the patterning, however, a shadow mask is required for the organic raw material (base) or the inorganic raw material (base), so that the organic EL element and the inorganic EL element can not be miniaturized and thus, the high resolution of the organic EL element and the inorganic EL element can not be realized.

### SUMMERY OF THE INVENTION

It is an object of the present invention to present a new high density integrated light-emitting device where a plurality of illuminants are integrated high density.

In order to achieve the above object, this invention relates to a method for fabricating a high density integrated light-emitting device, comprising the steps of:
preparing a plurality of electrode pairs, electrode pieces of each electrode pair being opposite to one another, and
applying voltages to the electrode pairs so as to accumulate illuminants in between electrode pieces of the electrode pairs by using electric fields generated between the electrode pieces from the voltages.

According to the present invention, a plurality of minute electrode pairs are formed on a given substrate, and illuminants are accumulated by applying voltages to the electrode pairs and thus, using electric fields in between the electrode pieces of the electrode pairs which are generated from the applied voltages. The electrode pairs can be miniaturized by means of conventional electron beam photolithography, and the distance between the electrode pieces of the electrode pairs can be also narrowed by means of the same electron beam photolithography.

The distance between the electrode pieces of the electrode pairs can be narrowed directly by the allowable processing limit of the electron beam photolithography, and the electrode pairs can be formed high density on the substrate. As a result, in the present invention, the illuminants can be accumulated higher density on the substrate through the high density formation of the electrode pairs than in the conventional light-emitting device using the shadow mask. In the present invention, therefore, the illuminants can be integrated high density on the substrate.

Herein, the electrode pairs can function solely for accumulating the illuminants, but can also function as driving electrodes to drive the resultant high density light-emitting device. In the latter case, it is not required that the electrode pairs can be removed after accumulating the illuminants, so that the formation of the electrode pairs can be included in the inherent fabricating process of the intended high density integrated light-emitting device. Therefore, the fabricating efficiency of the high density light-emitting device can be developed.

For example, if a transistor circuit is fabricated so as to include the above-mentioned electrode pairs, the illuminants can be accumulated and integrated by switching the transistor circuits and thus, applying voltages to the electrode pairs because the electrode pairs can function as transistor switches. In this case, the illuminants can be accumulated commensurate with the electrode pairs pattern as the transistor switches. Moreover, if some of the electrode pairs are selected, the illuminants can be accumulated in between the electrode pieces of the selected electrode pairs.

The same kind of illuminants can be accumulated in between the electrode pieces of the electrode pairs, but different kinds of illuminants can be accumulated in between the electrode pieces of the corresponding electrode pairs. In the latter case, the electrode pairs are classified into a plurality of groups, and the different kinds of illuminants are accumulated in between the electrode pieces of the corresponding electrode pair groups.

As mentioned above, according to the present invention can be provided a new high density integrated light-emitting device where illuminants are integrated high density.

### BRIEF DESCRIPTION OF THE DRAWINGS

For better understanding of the present invention, reference is made to the attached drawings, wherein

FIG. 1 illustrates a step in a fabricating method of a high density integrated light-emitting device according to the present invention,

FIG. 2 illustrates a step after the step illustrated in FIG. 1,

FIG. 3 illustrates a step after the step illustrated in FIG. 2,

FIG. 4 illustrates a step after the step illustrated in FIG. 3,

FIG. 5 illustrates a step in another fabricating method of a high density integrated light-emitting device according to the present invention,

FIG. 6 illustrates a step after the step illustrated in FIG. 5, and

FIG. 7 illustrates a modified fabricating method of a high density integrated light-emitting device according to the present invention.

### DESCRIPTION OF THE PREFERRED EMBODIMENTS

This invention will be described in detail with reference to the accompanying drawings.

FIGS. 1-4 illustrate steps in a fabricating method of a high density integrated light-emitting device according to the present invention. For clarifying the features of the present invention, in these figures, only one electrode pair is formed.

First of all, as illustrated in FIG. 1, the electrode pair is formed so that the electrode pieces are opposite to one another. In this case, it is required that the electrode pair forms a condenser. In this point of view, the electrode pair may be formed in the same surface level as illustrated in FIG. 1(a), and also in the different surface level, i.e., vertically, as illustrated in FIG. 1(b). The electrode pair may be formed on a substrate of the intended high density integrated light-emitting device, but also floated above the substrate. Since the electrode pair can double as a driving electrode of the high density integrated light-emitting device, in addition to the formation electrode of illuminants, the electrode pair is generally formed on the substrate.

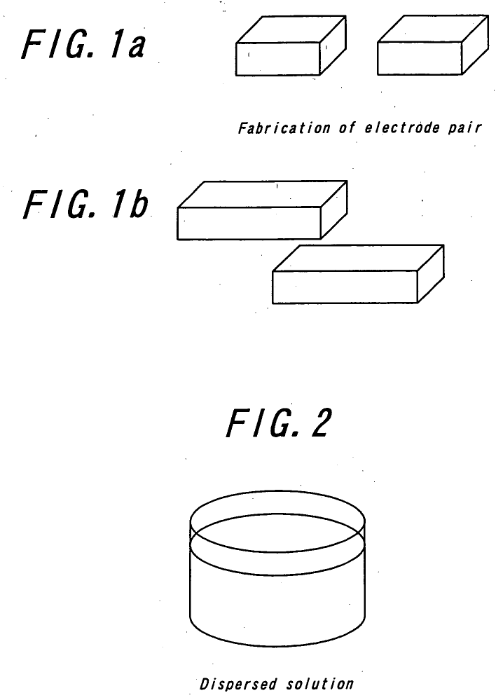

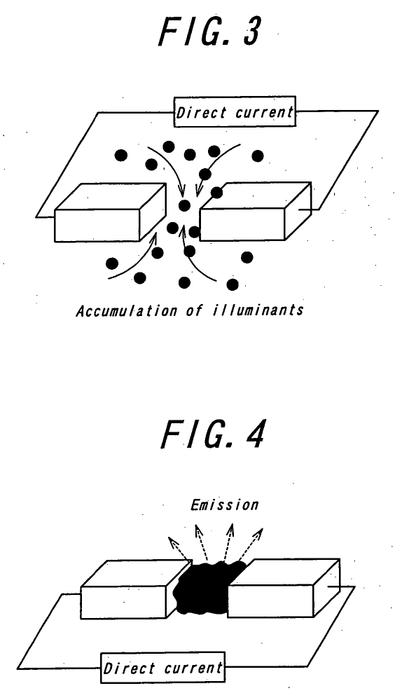

Then, as illustrated in FIG. 2, a nonpolar solvent with a smaller dielectric constant than the dielectric constant of the illuminants is prepared, and the illuminants are dispersed in the nonpolar solvent to form a given dispersed solution. Then, a given voltage is applied to the electrode pair as illustrated in FIG. 3 while the electrode pair is immersed in the dispersed solution. In this case, the illuminants are accumulated in between the electrode pieces of the electrode pair by the electric field generated in between the electrode pieces as illustrated in FIG. 4.

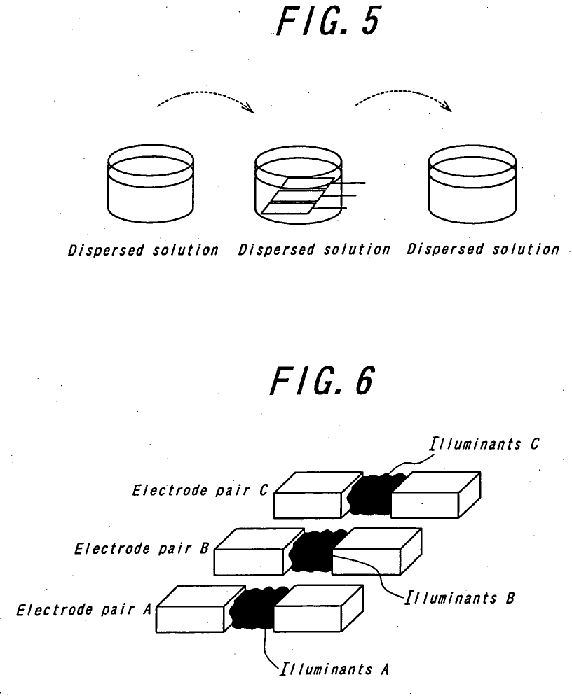

FIGS. 5 and 6 illustrate steps in another fabricating method of a high density integrated light-emitting device according to the present invention. In this embodiment, the illuminants A, B and C are dispersed in a given nonpolar solvent to form three kinds of dispersed solution as illustrated in FIG. 5. The dielectric constant of the nonpolar solvent is set smaller than the dielectric constants of the illuminants A, B and C. Then, the electrode pairs A, B and C are immersed successively in the dispersed solutions.

Herein, when the electrode pairs are immersed in the dispersed solution A, a given voltage is applied to the electrode pair A. When the electrode pairs are immersed in the dispersed solution B, a voltage is applied to the electrode pair B. When the electrode pairs are immersed in the dispersed solution C, a voltage is applied to the electrode pair C. In this case, the illuminants A are accumulated in between the electrode pieces of the electrode pair A, and the illuminants B are accumulated in between the electrode pieces of the electrode pair B, and the illuminants C are accumulated in between the electrode pieces of the electrode pair C. As a result, the three different kinds of illuminants can be accumulated in between the electrode pieces of the corresponding electrode pairs. Therefore, a high density light-emitting device which can emit multicolored lights can be fabricated.

In the fabrication of the intended high density integrated light-emitting device, it is required that the illuminants are formed high density. In this point of view, the electrode pairs must be narrowed and thus, arranged high density. Generally, the intended light-emitting device is fabricated on the substrate, so that the illuminants must be accumulated and integrated high density on the substrate. In this point of view, the above-mentioned steps relating to FIGS. 3 and 4 must be performed by immersing the substrate with the high density electrode pairs in the dispersed solution(s), instead of immersing only the electrode pairs.

In the fabrication of the high density integrated light-emitting device, the electrode pairs can be formed one-, two- or three-dimensionally so that the illuminants can be formed one-, two or three-dimensionally, respectively.

The electrode pair can be formed by means of photolithography technique using electron beam exposure or ultrashort ultraviolet light beam exposure or of anodic oxidation technique using an atom force microscope. In this case, the electrode pair can be narrowed sufficiently within the allowable processing limits of the above-mentioned techniques. Therefore, the electrode pairs can be formed high density on the substrate, so that the illuminants can be accumulated and integrated in between the electrode pieces of the electrode pairs on the substrate commensurate with the high density formation of the electrode pairs in comparison with a conventional method using shadow masking technique.

The electrode pair can be made of a semiconductor material such as Si, a metallic material such as Au, Al, Mg or ITO, a laminated structure of a semiconductor layer and a metal layer or of metal layers.

The distance between the electrode pieces of the electrode pair can be narrowed below the emission wavelength from the illuminants. In this case, the high density integrated light-emitting device can emit a light with a light spot in size smaller than the diffraction limit thereof, so can be used as a displaying device, a high density optical communication device or a living body measuring device.

In this embodiment (present invention), the distance between the electrode pieces of the electrode pair can be narrowed within 50 nm-10 μm, particularly within 50 nm-5 μm.

It is desired that the illuminants are made of nano-particles with diameters of 10 nm or below which can exhibit quantum size effect. As the nano-particles can be exemplified CdSe nano-particles, CdTe nano-particles or PbS nano-particles. The nano-particles can be made of at least one selected from the group consisting of CdSe nano-particles, CdTe nano-particles and PbS nano-particles. The CdSe nano-particles can emit a light within a range of blue light wavelength to red light wavelength through excitation. The CdTe nano-particles can also emit a light within a range of blue light wavelength to red light wavelength through excitation. The PbS nano-particles can emit a light within an infrared light wavelength (electromagnetic wave) through excitation. Herein, the emissive light wavelength from the nano-particles depends on the sizes of the nano-particles and the like.

In this point of view, when the nano-particles are appropriately selected, the emissive light wavelength from the nano-particles, i.e., the illuminants can be controlled (changed) by adjusting the sizes of the nano-particles.

As the nonpolar solvent can be exemplified toluene or hexane.

After the illuminants are accumulated in between the electrode pieces of the electrode pair, the assembly including the electrode pair and the illuminants may be annealed, e.g., within a temperature range of 100-400° C. under nitrogen or air atmosphere.

Moreover, a protective film which is transparent within an emissive light wavelength range of the illuminants can be formed over the assembly. In this case, the oxidization of the illuminants and the moisture adhesion can be prevented, so that the life duration of the high density integrated light-emitting device can be elongated.

As the transparent material to be used for the protective film can be exemplified an organic material such as parylene or an inorganic material such as SiO₂.

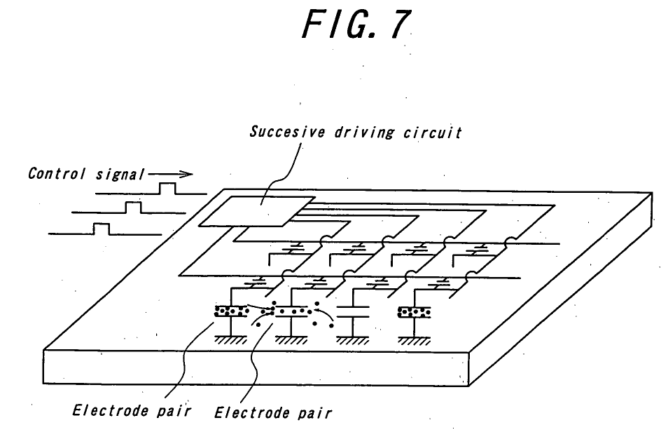

FIG. 7 illustrates a modified fabricating method of a high density integrated light-emitting device according to the present invention. In this embodiment illustrated in FIG. 7, the electrode pairs constituting the condensers are arranged in matrix to form a transistor circuit. The transistor circuit is switched by applying voltages to the electrode pairs while the transistor circuit is immersed in a dispersed solution containing illuminants, so that the illuminants are accumulated in between the electrode pieces of the electrode pairs. In this case, the electrode pairs function as the driving circuits, in addition to the accumulating electrodes. As a result, the intended high density integrated light-emitting device can be fabricated directly using the transistor circuit.

In this embodiment, if voltages are applied to the electrode pairs selectively and successively so that the electrode pairs are switched selectively and successively while the transistor circuit is immersed in the dispersed solutions containing the corresponding different kinds of illuminants, respectively, the different kinds of illuminants can be accumulated in between the electrode pieces of the corresponding electrode pairs of the transistor circuit.

Although the present invention was described in detail with reference to the above examples, this invention is not limited to the above disclosure and every kind of variation and modification may be made without departing from the scope of the present invention.

1. A method for fabricating a high density integrated light-emitting device, comprising the steps of:
preparing a plurality of electrode pairs, electrode pieces of each electrode pair being opposite to one another, and
applying voltages to said electrode pairs so as to accumulate illuminants in between electrode pieces of said electrode pairs by using electric fields generated between said electrode pieces from said voltages.

2. The fabricating method as defined in claim 1, further comprising the step of preparing a nonpolar solvent with a smaller dielectric constant than a dielectric constant of said illuminants, wherein said voltages are applied to said electrode pairs to accumulate said illuminants in between said electrode pieces of said electrode pairs.

3. A method for fabricating a high density integrated light-emitting device, comprising the steps of:
preparing a plurality of electrode pairs, electrode pieces of each electrode pair being opposite to one another,
classifying said electrode pairs into a plurality of groups, and
applying voltages to electrode pairs by each classified group so as to accumulate different illuminants in between electrode pieces of said electrode pairs by each classified group by using electric fields generated between said electrode pieces from said voltages.

4. A method for fabricating a high density integrated light-emitting device, comprising the steps of:
preparing a plurality of electrode pairs, electrode pieces of each electrode pair being opposite to one another,
classifying said electrode pairs into a plurality of groups,
preparing a different kinds of illuminants,
preparing a nonpolar solvent with a smaller dielectric constant than dielectric constants of said illuminants,
dispersing said different kinds of illuminants in said nonpolar solvent to form different kinds of dispersed solution, and
applying voltages to said electrode pairs by each classified group commensurate with the corresponding kind of dispersed solution while said electrode pairs are immersed in said different kinds of dispersed solution, thereby to accumulate said different kinds of illuminants in between electrode pieces of said electrode pairs by each classified group.

5. The fabricating method as defined in claim 2, wherein said illuminants are made of nano-particles with sizes of 10 nm or below.

6. The fabricating method as defined in claim 5, further comprising the step of controlling emissive light wavelengths from said illuminants by adjusting said sizes of said nano-particles making of said illuminants.

7. The fabricating method as defined in claim 5, wherein said illuminants are made of at least one selected from the group consisting of CdSe nano-particles, CdTe nano-particles and PbS nano-particles.

8. The fabricating method as defined in claim 4, wherein said illuminants are made of nano-particles with sizes of 10 nm or below.

9. The fabricating method as defined in claim 8, further comprising the step of controlling emissive light wavelengths from said illuminants by adjusting said sizes of said nano-particles making of said illuminants.

10. The fabricating method as defined in claim 8, wherein said illuminants are made of at least one selected from the group consisting of CdSe nano-particles, CdTe nano-particles and PbS nano-particles.

11. The fabricating method as defined in claim 1, wherein distances of said electrode pieces of said electrode pairs are set smaller than an emissive light wavelength of said illuminants.

12. The fabricating method as defined in claim 11, wherein said distances are set within 50 nm-10 μm.

13. The fabricating method as defined in claim 1, wherein said electrode pairs and said illuminants are arranged in matrix on a given substrate.

14. The fabricating method as defined in claim 1, wherein said electrode pairs function as driving electrodes of said high density integrated light-emitting device.

15. The fabricating method as defined in claim 14, wherein said electrode pairs compose a given transistor circuit.

16. The fabricating method as defined in claim 3, wherein distances of said electrode pieces of said electrode pairs are set smaller than emissive light wavelengths of said illuminants.

17. The fabricating method as defined in claim 16, wherein said distances are set within 50 nm-10 μm.

18. The fabricating method as defined in claim 3, wherein said electrode pairs and said illuminants are arranged in matrix on a given substrate.

19. The fabricating method as defined in claim 3, wherein said electrode pairs function as driving electrodes of said high density integrated light-emitting device.

20. The fabricating method as defined in claim 19, wherein said electrode pairs compose a given transistor circuit.

21. The fabricating method as defined in claim 4, wherein distances of said electrode pieces of said electrode pairs are set smaller than emissive light wavelengths of said illuminants.

22. The fabricating method as defined in claim 21, wherein said distances are set within 50 nm-10 μm.

23. The fabricating method as defined in claim 4, wherein said electrode pairs and said illuminants are arranged in matrix on a given substrate.

24. The fabricating method as defined in claim 4, wherein said electrode pairs function as driving electrodes of said high density integrated light-emitting device.

25. The fabricating method as defined in claim 24, wherein said electrode pairs compose a given transistor circuit.

26. The fabricating method as defined in claim 1, further comprising the step of annealing an assembly including said electrode pairs and said illuminants after said illuminants are accumulated and integrated in between said electrode pieces of said electrode pairs.

27. The fabricating method as defined in claim 26, wherein said assembly is annealed within a temperature range of 100-400° C. under nitrogen or air atmosphere.

28. The fabricating method as defined in claim 1, further comprising the step of forming a protective film which is transparent within an emissive light wavelength range from said illuminants over said assembly including said electrode pairs and said illuminants after said illuminants are accumulated and integrated in between said electrode pieces of said electrode pairs.

29. The fabricating method as defined in claim 3, further comprising the step of annealing an assembly including said electrode pairs and said illuminants after said illuminants are accumulated and integrated in between said electrode pieces of said electrode pairs.

30. The fabricating method as defined in claim 29, wherein said assembly is annealed within a temperature range of 100-400° C. under nitrogen or air atmosphere.

31. The fabricating method as defined in claim 3, further comprising the step of forming a protective film which is transparent within emissive light wavelengths range from said illuminants over said assembly including said electrode pairs and said illuminants after said illuminants are accumulated and integrated in between said electrode pieces of said electrode pairs.

32. The fabricating method as defined in claim 4, further comprising the step of annealing an assembly including said electrode pairs and said illuminants after said illuminants are accumulated and integrated in between said electrode pieces of said electrode pairs.

33. The fabricating method as defined in claim 32, wherein said assembly is annealed within a temperature range of 100-400° C. under nitrogen or air atmosphere.

34. The fabricating method as defined in claim 4, further comprising the step of forming a protective film which is transparent within emissive light wavelengths range from said illuminants over said assembly including said electrode pairs and said illuminants after said illuminants are accumulated and integrated in between said electrode pieces of said electrode pairs.

35. The fabricating method as defined in claim 1, wherein said high density integrated light-emitting device is a displaying device.

36. The fabricating method as defined in claim 1, wherein said high density integrated light-emitting device is a high density optical communication device.

37. The fabricating method as defined in claim 1, wherein said high density integrated light-emitting device is a living body-measuring device.

38. The fabricating method as defined in claim 3, wherein said high density integrated light-emitting device is a displaying device.

39. The fabricating method as defined in claim 3, wherein said high density integrated light-emitting device is a high density optical communication device.

40. The fabricating method as defined in claim 3, wherein said high density integrated light-emitting device is a living body-measuring device.

41. The fabricating method as defined in claim 4, wherein said high density integrated light-emitting device is a displaying device.

42. The fabricating method as defined in claim 4, wherein said high density integrated light-emitting device is a high density optical communication device.

43. The fabricating method as defined in claim 4, wherein said high density integrated light-emitting device is a living body-measuring device.

44. A high density integrated light-emitting device comprising:
a plurality of electrode pairs, electrode pieces of each electrode pair being opposite to one another, and
illuminants which are accumulated and integrated in between electrode pieces of said electrode pairs,
wherein distances between said electrode pieces of said electrode pairs are set to an emissive light wavelength from said illuminants.

45. The high density integrated light-emitting device as defined in claim 44, wherein sizes of said illuminants are set to 10 nm or below, and made of at least one selected from the group consisting of CdSe nano-particles, CdTe nano-particles and PbS nano-particles.

46. A high density integrated light-emitting device comprising:
a plurality of electrode pairs, electrode pieces of each electrode pair being opposite to one another, and
illuminants which are accumulated and integrated in between electrode pieces of said electrode pairs,
wherein said illuminants are made of nano-particles with sizes of 10 nm or below, and an emissive light wavelength from said illuminants is controlled by adjusting sizes of said nano-particles.

47. The high density integrated light-emitting device as defined in claim 46, wherein said nano-particles are made of at least one selected from the group consisting of CdSe nano-particles, CdTe nano-particles and PbS nano-particles.

48. The high density integrated light-emitting device as defined in claim 44, constituting a displaying device.

49. The high density integrated light-emitting device as defined in claim 44, constituting a high density optical communication device.

50. The high density integrated light-emitting device as defined in claim 44, constituting a living body-measuring device.

51. The high density integrated light-emitting device as defined in claim 46, constituting a displaying device.

52. The high density integrated light-emitting device as defined in claim 46, constituting a high density optical communication device.

53. The high density integrated light-emitting device as defined in claim 46, constituting a living body-measuring device.
distances between said electrode pieces of said electrode pairs are set to an emissive light wavelength from said illuminants.
